(19) United States
(12) Patent Application Publication
(10) Pub. No.: US 2022/0373003 A1
(43) Pub. Date: Nov. 24, 2022

(54) DIFFERENTIAL HYDRAULIC BUFFER

(71) Applicant: ClearMotion, Inc., Billerica, MA (US)

(72) Inventors: Colin Patrick O'Shea, Cambridge, MA (US); Brian Alexander Selden, Concord, MA (US); Clive Tucker, Charlestown, MA (US)

(73) Assignee: ClearMotion, Inc., Billerica, MA (US)

(21) Appl. No.: 17/775,567

(22) PCT Filed: Nov. 13, 2020
(86) PCT No.: PCT/US2020/060577

§ 371 Date: May 9, 2022

Related U.S. Application Data
(60) Provisional application No. 62/935,047, filed on Nov. 13, 2019.

(51) Int. Cl. F15B 21/00

(52) U.S. Cl. CPC F15B 21/008; F15B 2211/20569

(57) ABSTRACT

Hydraulic systems and methods for reducing the propagation of flow and/or pressure pulsations within a hydraulic system are described. In one embodiment, a hydraulic system may include a hydraulic device and a differential buffer fluidly connected to the hydraulic device. The differential buffer may include a piston that is exposed to pressure pulsations that propagate along separate flow paths and that are at least partially out of phase with one another. Corresponding displacement of the piston due to the out of phase pulsations may at least partially mitigate propagation of the pulsations within the hydraulic system downstream from the differential buffer.

### CROSS-REFERENCE TO RELATED APPLICATIONS

This application claims the benefit under 35 U.S.C. § 119(e) of U.S. provisional application Ser. No. 62/935,047, filed Nov. 13, 2019, the disclosure of which is incorporated herein by reference in its entirety.

### FIELD

Disclosed embodiments may be related to methods and systems for the mitigation of flow and/or pressure pulsations in hydraulic systems. Some embodiments may be directed to hydraulic systems including differential hydraulic buffers.

### BACKGROUND

Hydraulic systems, which take advantage of fluids to store, convert, and/or transmit power, are utilized across a variety of industries and applications, from large scale industrial plants to motor vehicles. These hydraulic systems may generally include a variety of components, such as, for example, hydraulic pumps, valves, various reservoirs or accumulators, tanks, fluid chambers, filters, membranes, other hydraulic components, and the flow paths extending between these components. The flow of hydraulic fluid through and/or between these various components and connections may result in fluid pressure and/or flow pulsations that may produce vibrations of the components and/or acoustic noise. This may be undesirable due to the generation of objectionable levels of noise, accelerated wear and tear on equipment, and/or reduced system performance in associated frequency ranges.

### SUMMARY

In one embodiment, a hydraulic system includes a hydraulic device with a first device port and a second device port; a differential buffer with a first buffer port and a second buffer port; a first flow path that fluidly connects the first device port to the first buffer port; and a second flow path that fluidly connects the second device port with the second buffer port.

In one embodiment, an active suspension actuator system includes a hydraulic device including a first device port and a second device port. The active suspension actuator system also includes a differential buffer with a first buffer chamber and a second buffer chamber that are fluidly separated by a buffer piston slidably received in the differential buffer. The first buffer chamber is fluidly connected to the first port of the hydraulic device and the second buffer chamber is fluidly connected to the second port of the hydraulic device. The active suspension actuator system also includes a hydraulic actuator with a first actuator chamber and a second actuator chamber that are fluidly separated by an actuator piston slidably received in the hydraulic actuator. The first actuator chamber is fluidly connected to the first buffer chamber and the second actuator chamber is fluidly connected to the second buffer chamber.

In one embodiment, a method for operating a hydraulic system includes: applying flow pulsations to a first flow path fluidly connected to a first buffer chamber and a second flow path fluidly connected to a second buffer chamber, where the flow pulsations in the first buffer chamber are at least partially out of phase with the flow pulsations in the second buffer chamber; and displacing a buffer piston disposed between the first buffer volume and the second buffer volume due at least in part to a phase difference between the flow pulsations in the first and second buffer chambers.

In one embodiment, a hydraulic system includes: a hydraulic device with a first device port and a second device port; a differential buffer with a first buffer port and a second buffer port; a first flow path that fluidly connects the first device port to the first buffer port; and a second flow path that fluidly connects the second device port with the second buffer port.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various nonlimiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF FIGURES

The accompanying drawings are not intended to be drawn to scale. In the drawings, each identical or nearly identical component that is illustrated in the various figures may be represented by a like numeral. For purposes of clarity, not every component may be labeled in every drawing. In the drawings:

FIG. 1 illustrates one embodiment of a hydraulic circuit with a reversible hydraulic device and a hydraulic load;

FIG. 2 illustrates one embodiment of the expected behavior of hydraulic pressure at each of the two ports of the reversible hydraulic device in FIG. 1 for an exemplary operating condition;

FIG. 3 illustrates one embodiment of the expected fluid discharge rate from and fluid intake rate at the two ports of the reversible hydraulic device of FIG. 1 for an exemplary operating condition;

FIG. 4 illustrates one embodiment of a hydraulic circuit with a reversible hydraulic device, a hydraulic load, and two accumulators;

FIG. 5 illustrates one embodiment of a hydraulic circuit with a reversible hydraulic device, a hydraulic load, and a differential buffer;

FIG. 6 illustrates one embodiment of a hydraulic circuit with a reversible hydraulic device, a hydraulic active suspension actuator, an accumulator, and a differential buffer in a flow-through configuration;

FIG. 7A illustrates a cross section of one embodiment of Belleville washers stacked in a parallel arrangement;

FIG. 7B illustrates a cross section of one embodiment of Belleville washers stacked in a series arrangement;

FIG. 7C illustrates a cross section of one embodiment of Belleville washers stacked using a combination of Belleville washers stacked in parallel and series;

FIG. 8 illustrates one embodiment of a hydraulic device and flow-through differential buffer where the springs include parallel arrangements of Belleville washers disposed on either side of a buffer piston;

FIG. 9 illustrates a perspective cross section of an embodiment of a differential buffer with springs in the form of opposing stacks of Belleville washers disposed on either side of a buffer piston;

FIG. 10 illustrates a front cross sectional view of the differential buffer of FIG. 9;

FIG. 11A illustrates one embodiment of a differential buffer similar to that shown in FIGS. 9-10 with the piston in a first neutral operational position;

FIG. 11B illustrates the differential buffer of FIG. 11A with the piston in a second operational position;

FIG. 11C illustrates the differential buffer of FIG. 11A with the piston in a third operational position;

FIG. 12A is a perspective view of one embodiment of a Belleville washer stack that may be included in a differential buffer;

FIG. 12B is a cross-sectional perspective view of the Belleville washer stack of FIG. 12A; and

FIG. 12C is a close-up cross-sectional perspective view of the Belleville washer stack of FIG. 12B.

### DETAILED DESCRIPTION

The Inventors have recognized that hydraulic pumps, especially positive displacement pumps such as, for example, gerotor pumps, crescent pumps, gear pumps, and piston pumps may induce flow and/or pressure pulsations, which may also be referred to as ripple, at both the intake and discharge ports. These pulsations may be transmitted to, and observed at, various points over an entire hydraulic circuit. These pressure pulsations may result in increased noise and/or instability of the hydraulic system. Compliant reservoirs (e.g. accumulators) may be used to partially mitigate the transmission of flow and/or pressure pulsations to various portions of a hydraulic system. However, the Inventors have recognized that the use of larger reservoirs may result in more fluid needing to be moved by a pump, or other hydraulic device, in order to establish a desired pressure differential across the pump. Additionally, as a reservoir is compressed, the compliance may decrease in certain types of reservoirs (i.e. the reservoir may become stiffer). Therefore, the Inventors have recognized that a reservoir may be less effective in mitigating flow and/or pressure pulsations as it is compressed, and, for example, in the case of a gas filled reservoir, this relationship may be non-linear.

In view of the above, the Inventors have recognized the benefits associated with using a phase difference present in the flow and/or pressure pulsations present at locations along different flow paths connected to separate ports of a hydraulic device to reduce a magnitude of the flow and/or pressure pulsations that propagate to other portions of a hydraulic system. Specifically, a phase difference and relative magnitudes of the flow and/or pressure pulsations between the two flow paths may result in a pressure differential at a given location that is different from a nominal pressure differential between the flow paths applied by the hydraulic device. Accordingly, the portion of the pressure differential associated with the out of phase flow and/or pressure pulsations along the different flow paths may be used to at least partially mitigate the flow and/or pressure pulsations propagating to another portion of the hydraulic system. For example, in some embodiments, this pressure differential between the two flow paths associated with the flow and/or pressure pulsations may be used to cause a corresponding change in volume of a buffer chamber associated with each flow path to at least partially mitigate, and in some instances substantially eliminate, the flow and/or pressure pulsations. For instance, a volume change of the first buffer chamber may result in a corresponding opposite volume change in the second buffer chamber which may at least partially accommodate the at least partially out of phase flow and/or pressure pulsations that are applied to the separate buffer chambers. In some embodiments, this volume change may be accomplished using a buffer piston slidably disposed between, and separating, the two buffer chambers where the buffer piston may be displaced by the out of phase flow and/or pressure pulsations applied to the two buffer chambers. Specific embodiments are elaborated on further below.

In one embodiment, a hydraulic system may include a hydraulic device (e.g. a hydraulic motor or a pump) with a first device port and a second device port. For example, the hydraulic device may be a hydraulic pump operated as a hydraulic pump in at least one mode of operation or a hydraulic motor operated as a hydraulic pump in at least one mode of operation. The embodiment may include a differential buffer with a first buffer port and a second buffer port. A first flow path may fluidly connect the first device port to the first buffer port and a second flow path may fluidly connect the second device port with the second buffer port. The differential buffer may function to reduce flow and/or pressure pulsations generated by the hydraulic device that are transmitted from the differential buffer to one or more hydraulic loads fluidly connected to the differential buffer.

In some embodiments, a differential buffer may include a housing with an internal volume that includes a first buffer chamber and a second buffer chamber. A buffer piston disposed in the housing of the differential buffer between the first and second buffer chambers may be configured to slide back and forth under the influence of a differential pressure applied across the buffer piston between the two buffer chambers. A first spring may resist motion of the buffer piston in a first direction and a second spring may resist motion of the buffer piston in a second direction that is opposite the first direction. Accordingly, the piston may move under the applied pressure differential associated with flow and/or pressure pulsations generated by the hydraulic device which may correspondingly vary a volume of the first and second buffer chambers to at least partially cancel the at least partially out of phase flow and/or pressure pulsations that are transmitted to the first and second chambers.

While the differential buffers and systems disclosed herein may be used with any appropriate hydraulic load, in some embodiments, the hydraulic load fluidly connected to a hydraulic device, as described herein, may be an active suspension actuator. In one such embodiment, an active suspension actuator system may include a hydraulic device, such as a hydraulic pump or a hydraulic motor. The hydraulic device may include a first device port and a second device port. The embodiment may also include a differential buffer with a first buffer chamber and a second buffer chamber that are fluidly separated by a buffer piston that is disposed between the first and second buffer chambers. The buffer piston may be configured to slide within a housing of the differential buffer between the first and second buffer chambers. For example, the buffer piston may be slidably retained within a cylindrical volume that at least partially defines the first and second buffer chambers. The first buffer chamber may be fluidly connected to the first device port of the hydraulic device and the second buffer chamber may be fluidly connected to the second device port of the hydraulic device. The active suspension system may also include a hydraulic actuator with a first actuator chamber and a second actuator chamber. In some embodiments, the first and second actuator chambers may correspond to extension and compression chambers of the actuator, respectively. In either case, the first and second actuator chambers may be fluidly separated by an actuator piston. In some embodiments, the actuator piston may be slidably received within a cylindrical volume disposed within an interior volume of the actuator body that at least partially defines the first and second actuator chambers. Regardless of the specific construction, the first actuator chamber may be fluidly connected to the first buffer chamber and the second actuator chamber may be fluidly connected to the second buffer chamber. As elaborated on further below, such a construction may help reduce a magnitude of flow and/or pressure pulsations that may be transmitted from the hydraulic device to the actuator through the differential buffer.

Certain parameters related to the operation of a hydraulic system, including the ability of a differential buffer to mitigate flow and/or pressure pulsations within the hydraulic system, may be at least partially related to a frequency range of operation of the hydraulic system and a resulting frequency range of the excited flow and/or pressure pulsations. Accordingly, in some embodiments, the various operating parameters and performance characteristics described herein may correspond to operating parameters and/or performance characteristics within the operating frequency ranges and flow and/or pressure pulsation frequency ranges noted below.

Depending on the embodiment, a hydraulic device may exhibit any appropriate operating frequency range. For example, a maximum response frequency of a hydraulic device may be greater than or equal to 1 Hz, 5 Hz, 10 Hz, 20 Hz, and/or any other appropriate frequency range. Correspondingly, the hydraulic device may have a maximum response frequency that is less than or equal to 100 Hz, 50 Hz, 40 Hz, 30 Hz, 20 Hz, and/or any other appropriate frequency range. Combinations of the above noted frequency ranges are contemplated including, a hydraulic device that it is capable of responding with a maximum frequency response that is between or equal to 1 Hz and 50 Hz. Further, a hydraulic device may have an operating frequency range that extends between or equal to 0 Hz and any of the above-noted maximum response frequencies. However, embodiments in which a hydraulic device has a different lower bound for the operating frequency range that is greater than 0 Hz is also contemplated as the disclosure is not so limited. Additionally, while specific frequency ranges for the maximum response frequency of a hydraulic device are noted above, it should be understood that any appropriate range of operating frequencies for a hydraulic device, including ranges both greater and less than those noted above, may be used depending on the specific application as the disclosure is not limited in this fashion. Additionally, while maximum response frequencies are described above, the operational speeds of a particular hydraulic device may be greater than the frequencies associated with a maximum response time of the device in certain embodiments. For example, a hydraulic device such as a gerotor, or other similar device, may exhibit rotational velocities with cyclic excitations having frequencies greater than the maximum response frequencies noted above in some embodiments.

In some embodiments, a hydraulic device may generate flow and/or pressure pulsations within a range of different pulsation frequencies. For example, a flow and/or pressure pulsation generated by a hydraulic device may have a frequency that is greater than or equal to 10 Hz, 20 Hz, 30 Hz, 40 Hz, 50 Hz, 100 Hz, 500 Hz, 1000 Hz, 2000 Hz, 3000 Hz, and/or any other appropriate frequency range. Correspondingly, the frequency range associated with the flow and/or pressure pulsations may be less than or equal to 10,000 Hz, 5000 Hz, 4000 Hz, 3000 Hz, 2000 Hz, 1000 Hz, 500 Hz, 100 Hz, 50 Hz, and/or any other appropriate frequency range. Combinations of the foregoing frequency ranges are contemplated including, for example, a frequency range of flow and/or pressure pulsations that is between or equal to 10 Hz and 10,000 Hz as well as 30 Hz and 300 Hz. Of course, it should be understood that depending on the specific hydraulic system construction, frequency ranges for flow and/or pressure pulsations both greater than and less than those noted above are contemplated as the disclosure is not so limited.

As noted above, a hydraulic device, such as a pump or hydraulic motor, may generate flow and/or pressure pulsations along, for example, two separate flow paths that are fluidly connected to separate ports of the hydraulic device. These pulsations propagating along the separate flow paths may be at least partially out of phase with one another. When the pressure pulsations at a particular location along the flow paths, such as within two opposing buffer chambers, are completely out of phase with one another, i.e. 180° out of phase, a maximum amount of mitigation of the flow and/or pressure pulsations may be achieved as elaborated on further below. Alternatively, when pulsations at a particular location along the flow paths, such as within two opposing buffer chambers, are partially out of phase with one another, i.e. less than 180° out of phase, a lesser amount of mitigation of the flow and/or pressure pulsations may be achievable. Additionally, to further enhance the amount of pulsation mitigation provided by a differential buffer, it may be desirable for a magnitude of the flow and/or pressure pulsations transmitted to opposing buffer chambers from the two separate flow paths to be approximately equal in magnitude to one another. As elaborated on further below, the phase and magnitude of the pulsations present along the separate flow paths of a hydraulic system to an associated differential buffer may be dependent on the mass of the fluid in the flow paths, the damping, and/or the stiffness of the fluid flow paths extending between and including the hydraulic device generating the flow and/or pressure pulsations as well as the separate chambers of the differential buffer connected to these fluid flow paths. Thus, there may be an appropriate transfer function, which may be the result of the particular hydraulic system construction, that relates the magnitude and/or phase of pulsations emitted from a port of a hydraulic device to the magnitude and phase of pulsations that occur at a port of a differential buffer of the system. These transfer functions may be experimentally measured as elaborated on below to determine the various operating parameters of a hydraulic system.

In view of the above, the flow and/or pressure pulsations transmitted to opposing first and second chambers of a differential buffer may be matched with one another at least within a desired frequency range such that they are close to or effectively 180° out of phase with one another within the opposing chambers of the differential buffer. In some embodiments, the flow and/or pressure pulsations applied to opposing chambers of the differential buffer at least within a desired frequency range of the pulsations may be within 40°, 30°, 20°, 10°, 5°, 1°, and/or any other appropriate offset from being 180° out of phase with one another (e.g. between or equal to 140° and 220° out of phase). That said, pressure pulsations that are offset from being 180° out of phase with one another by amounts greater than those noted above are also contemplated as the disclosure is not so limited.

In some embodiments, a magnitude of flow and/or pressure pulsations within a desired or targeted frequency range that are transmitted from a hydraulic device to opposing buffer chambers of a differential buffer may be substantially or effectively equal to one another. For example, a difference between a magnitude of the flow and/or pressure pulsations applied to the opposing buffer chambers within a desired or targeted frequency range of the pulsations may be less than or equal to 20%, 15%, 10%, 5%, 1% and/or any other appropriate percentage of the larger amplitude pulsation in a buffer chamber at a given frequency. Of course, magnitude differences between the pulsations applied to the different chambers greater than the ranges noted above are also contemplated as the disclosure is not so limited.

To help provide a desired relationship between a magnitude and/or phase of pulsations applied to opposing chambers of a differential buffer within a desired or targeted frequency range of the pulsations, it may be desirable to provide flow paths connecting ports of a hydraulic device to the corresponding buffer chambers of a differential buffer that have approximately equivalent compliances corresponding to the expected change in volume for a given change in pressure. It should be noted that due to the flow paths including a substantially incompressible fluid, such as a hydraulic fluid, a majority of the compliance along these flow paths may be provided by the differential buffer itself. In either case, a difference in the compliance between a first flow path fluidly connecting a first device port of a hydraulic device to a first buffer chamber of a differential buffer relative to a second flow path fluidly connecting a second device port of the hydraulic device to a second buffer chamber of the differential buffer may be less than or equal to 20%, 15%, 10%, 5%, 4%, 3%, 2%, 1%, and/or any other appropriate percentage of the larger compliance as the disclosure is not so limited. However, differences in the compliances of the two fluid flow paths greater than those noted above are also contemplated as the disclosure is not so limited.

Alternatively or additionally, to help provide a desired relationship between a magnitude and/or phase of pulsations applied to opposing chambers of a differential buffer within a desired frequency range of the pulsations, it may also be desirable to provide approximately equivalent fluid impedances for the separate flow paths connecting the separate ports of a hydraulic device to the corresponding buffer chambers of a differential buffer. The fluid impedance along each flow path may include contributions from flow resistances and the mass of the fluid extending between the hydraulic device and differential buffer. However, in some embodiments, the fluid impedance may be dominated by frictional losses along the flow path. In either case, a difference in the fluid impedance along a first flow path fluidly connecting a first device port of a hydraulic device to a first buffer chamber of a differential buffer and a second flow path fluidly connecting a second device port of the hydraulic device to a second buffer chamber of the differential buffer may be less than or equal to 20%, 15%, 10%, 5%, 4%, 3%, 2%, 1%, and/or any other appropriate percentage of the larger fluid impedance as the disclosure is not so limited. However, differences in the fluid impedances of the two fluid flow paths greater than those noted above are also contemplated as the disclosure is not so limited.

In some embodiments, a magnitude of flow and/or pressure pulsations that are transmitted from a differential buffer to a hydraulic load may be reduced relative to a magnitude of the flow and/or pressure pulsations generated by, and transmitted to, the differential buffer from a hydraulic device. Depending on the desired application, the reduction in magnitude may be any appropriate percentage. For example, a reduction in magnitude of the transmitted pulsations may be greater than or equal to 1%, 5%, 20%, 50%, or any other appropriate percentage of a magnitude of the original pressure and/or flow fluctuations prior to being reduced by the differential buffer. Correspondingly, the reduction in magnitude may be less than or equal to 80%, 50%, 20%, 5%, 1%, and/or any other appropriate percentage of a magnitude of the original pressure and/or flow fluctuations. Combinations of the foregoing are contemplated including, for example, a reduction in the magnitude of transmitted flow and/or pressure pulsations from a differential buffer to a fluidly connected hydraulic load that is between or equal to 50% and 80%. Of course, different combinations of the foregoing ranges as well as reductions that are both greater than and less than those noted above are also contemplated as the disclosure is not so limited.

Depending on the particular embodiment, the above-noted frequencies and phase offsets for flow and/or pressure pulsations within a system may be measured in any appropriate fashion. That said, in some embodiments, the frequency and phase of the pulsations may be measured using pressure sensors associated with the separate buffer chambers located within a differential buffer. For example, separate pressure sensors and/or a differential pressure sensor may be used to measure pressure pulsations within the different buffer chambers or other portions of the hydraulic system. However, it should be understood that other methods of measuring the frequency and/or phase of the flow and/or pressure pulsations with a system may also be used as the disclosure is not limited in this fashion.

The above-noted compliances and fluid impedances along the various flow paths may also be determined in any appropriate fashion. For example, in one embodiment, a computational fluid dynamic (CFD) analysis may be performed to determine the compliances and fluid impedances associated with the different flow paths of a hydraulic system. In another embodiment, these parameters may be measured experimentally.

The flow path transfer function between the pressure ripple source and the differential buffer may be measured experimentally. For example, this may be achieved by placing pressure sensors capable of measuring pressure at frequencies in the appropriate frequency range, for example 10-3000 Hz or 10-10000 Hz, at locations at opposite ends of the flow path. In some embodiments, during the experiment, the hydraulic device may be replaced with an external volumetric flow source which may then be used to induce volumetric fluid displacements at the same location as the pump (location 141 for example). By sweeping through excitations with the external flow source at frequencies throughout the desired range, the impedance of the flow paths can be measured. In some embodiments the magnitude and phase of the transfer function of the flow path connecting a first port of the hydraulic device and a first chamber of the differential buffer may have a magnitude and/or phase that is 20%, 15%, 10%, 5%, 4%, 3%, 2%, 1% and/or any other appropriate percentage less than the magnitude and/or phase of the transfer function of the flow path connecting a second port of the hydraulic device and a second chamber of the differential buffer.

As described further below, in some embodiments, one or more springs may be operatively coupled with a buffer piston slidably disposed between first and second buffer chambers of a differential buffer. In some embodiments, the one or more springs may include one or more springs disposed on either side of the buffer piston such that the springs bias the buffer piston towards a neutral position. Specific constructions are described further below in relation to the figures. However, it should be understood that any appropriate type of spring capable of applying a desired force to bias a buffer piston of the differential buffer towards a desired neutral position may be used as the disclosure is not limited to any particular type of spring. Thus, appropriate springs may include, but are not limited to, coil springs, Belleville washers, and/or any other appropriate type of spring capable of applying the appropriate forces.

As used herein, flow and/or pressure pulsations, flow and/or pressure ripple, flow pulsations, pressure pulsations, pulsations and other similar terms may be used interchangeably to refer to the same or equivalent physical phenomenon that may occur in some hydraulic systems. Specifically, flow and/or pressure pulsations may refer to the occurrence of flow and/or pressure pulsations that deviate from a nominal flow rate and/or nominal pressure, whether constant or variable, associated with the commanded operation of a hydraulic device along a given flow path fluidly connected to the hydraulic device. In some instances, these pulsations may cyclically vary such that the actual flow rate and pressure cyclically vary around the nominal commanded flow rate and/or pressure. For example, as described further below in reference to the figures, during operation of certain types of pumps, a flow and pressure along the different flow paths connected to the separate ports of the pump may vary throughout given cycle of a pumping mechanism of the pump.

As used herein the terms hydraulic device, hydraulic pump, and hydraulic motor may be used interchangeably with one another. Accordingly, the various embodiments described herein may include a hydraulic device corresponding to any appropriate hydraulic device capable of being driven to provide a desired flow of fluid and/or pressure differential at various points in a hydraulic system. This may include hydraulic pumps and hydraulic motors that may be configured to operate as a pump to drive a flow of fluid in at least one operating mode. Additionally, in some embodiments, a hydraulic device may include a pump or hydraulic motor that is configured to be operated as a hydraulic motor in at least one operating mode in which a flow of fluid is used to drive the hydraulic device. Depending on the particular application, it may be desirable for a hydraulic device, such as a hydraulic pump and/or hydraulic motor, to be reversible such that it may permit a fluid to flow through the hydraulic device in both a first direction and a second opposing direction. However, embodiments in which flow through a hydraulic device is unidirectional are also contemplated. Additionally, in some embodiments, hydraulic devices may operate at a variable nominal speed or a constant nominal speed as the disclosure is not so limited. Appropriate types of hydraulic devices may include, but are not limited to: positive displacement pumps such as gerotors, crescent pump, gear pumps, piston pumps, swash plate pumps.

The hydraulic systems and differential buffers disclosed herein may be used with any appropriate type of hydraulic load as the disclosure is not limited to any particular type of hydraulic system. However, in some embodiments, hydraulic loads that may be included in a hydraulic system as disclosed herein may include, but are not limited to, active suspension actuators, hydraulic actuators, and/or any other appropriate type of hydraulic load.

As used herein, a flow path may refer to a conduit or other enclosed passage through which fluid may flow between two or more points in a hydraulic circuit, such as for example, between two ports of separate hydraulic components in a hydraulic system. Appropriate types of flow paths may include but are not limited to, hydraulic tubes, channels formed in solid components, passages extending between two opposing surfaces of separate components (e.g., between concentrically located tubes or housings), and/or any other appropriate construction capable of functioning as a flow path to permit the flow of fluid between two or more points within a hydraulic system.

As used herein fluidly connecting, fluidly connected, fluid communication, and other similar terms, may refer a fluid connection between different points in a hydraulic circuit. For example, a flow path may fluidly connect two portions of a hydraulic circuit such that fluid may be exchanged between these two portions of the hydraulic circuit during at least some operating conditions. It should be understood that a fluid connection between two points of a hydraulic circuit may either be a direct fluid connection with no intervening components, e.g., flow control devices such as valves, between the two locations or an indirect connection where a flow path may extend between one or more intervening components between the two locations as the disclosure is not limited in this fashion.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

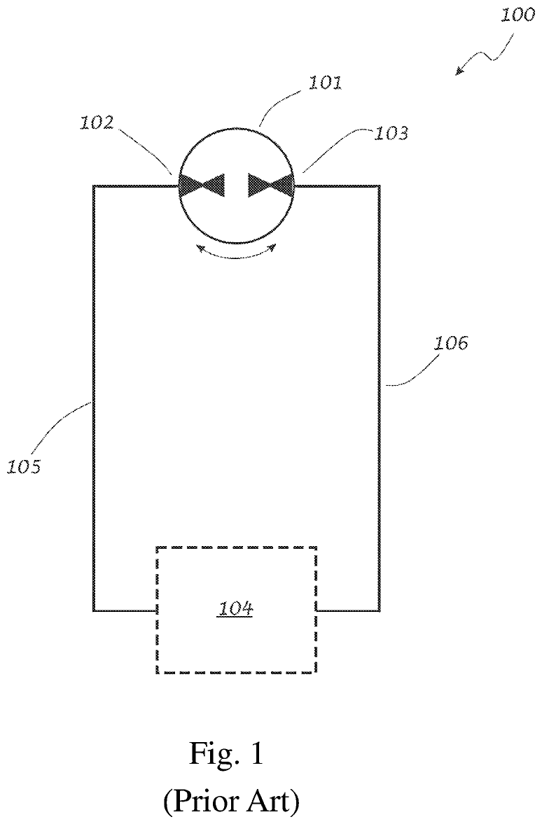

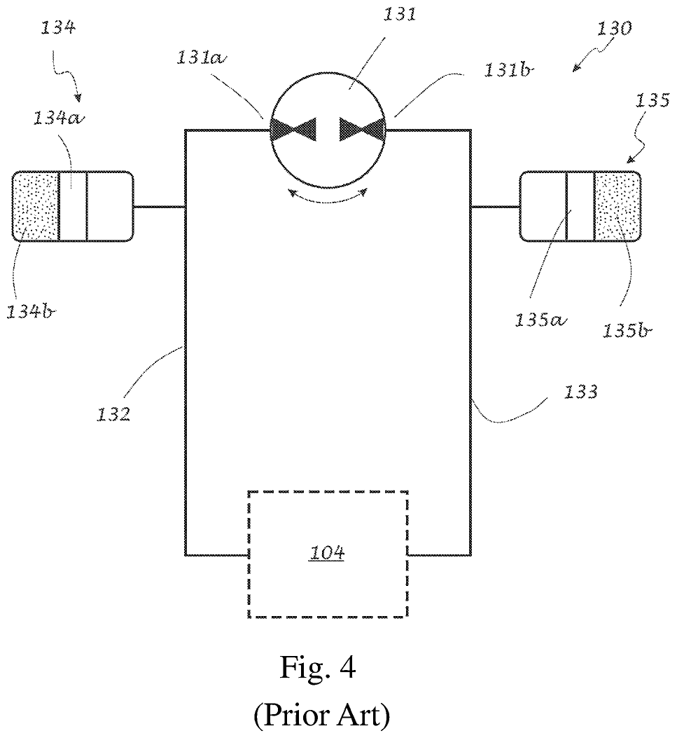

FIG. 1 illustrates a hydraulic circuit 100 that includes a reversible hydraulic device 101, such as a pump or hydraulic motor. The hydraulic device 101 illustrated in FIG. 1 (as well as in FIGS. 4, 5, and 6) is depicted to be reversible and capable of operating as a hydraulic pump and a hydraulic motor. It should be noted that, in some embodiments, a non-reversible hydraulic pump or hydraulic motor may be used. The hydraulic device 101 of hydraulic circuit 100 includes a first port 102 and a second port 103. Since hydraulic device 101 is reversible, depending on the specific operating conditions, either port may operate as an inlet or an outlet port. For example, for a gerotor, crescent pump, or gear pump, second port 102 may be an outlet port when the pump rotates in a first direction and an inlet port when the pump rotates in a second direction that is opposite the first direction. As indicate in FIG. 1, the hydraulic device 101 may also be operated as a hydraulic motor under certain operating conditions of the hydraulic load 104.

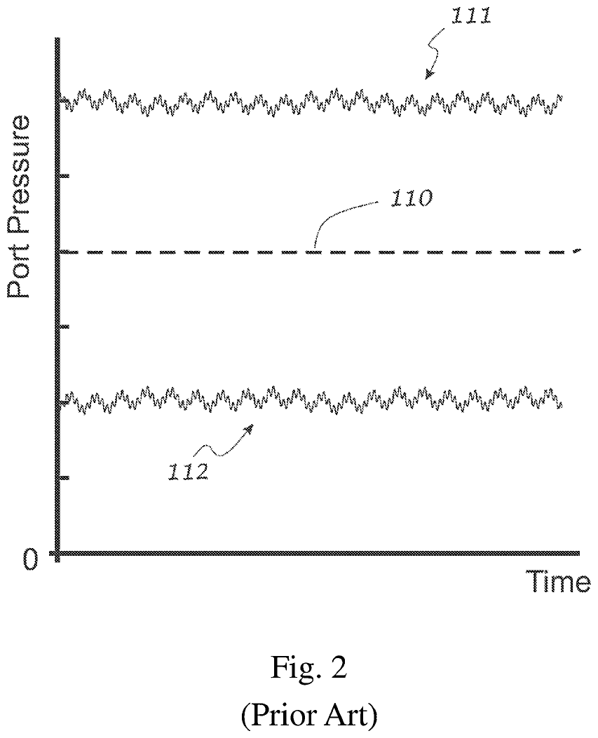

FIG. 2 presents a graph of pressure pulsations that may propagate along the flow paths 105 and 106 illustrated in the hydraulic circuit 100 of FIG. 1. In FIG. 2, dashed line 110 represents the system pressure, when the hydraulic device is not operating, i.e., the system pre-charge pressure. When the hydraulic device is operating at a constant speed, the nominal commanded pressure at the outlet port may be nominally constant and higher than the pre-charge pressure which is higher than the intake pressure (which may also be nominally constant and lower than the pre-charge pressure). However, while the pressure at the inlet and outlet ports may be nominally constant, as illustrated by traces 111 and 112, in FIG. 2, pressure fluctuations, i.e. pulsations, may be present at the inlet and outlet ports respectively even though the pump may be operating at a constant nominal speed. These pressure fluctuations may cyclically vary around the nominal commanded pressure at each port. Additionally, the pressure fluctuations may occur across a range of frequencies as illustrated by traces which include multiple fluctuations with different frequencies superimposed on the nominal commanded pressures at each port. Additionally, depending on the type of hydraulic device used to generate the pressure differential, and as can be seen in FIG. 2, pressure traces 111 and 112 may be mirror images of each other. This corresponds to the pressure pulsations at the two ports being at least partially out of phase with one another (e.g., in FIG. 2 the pressure pulsations are shown to be 180 degrees out of phase at the two ports).

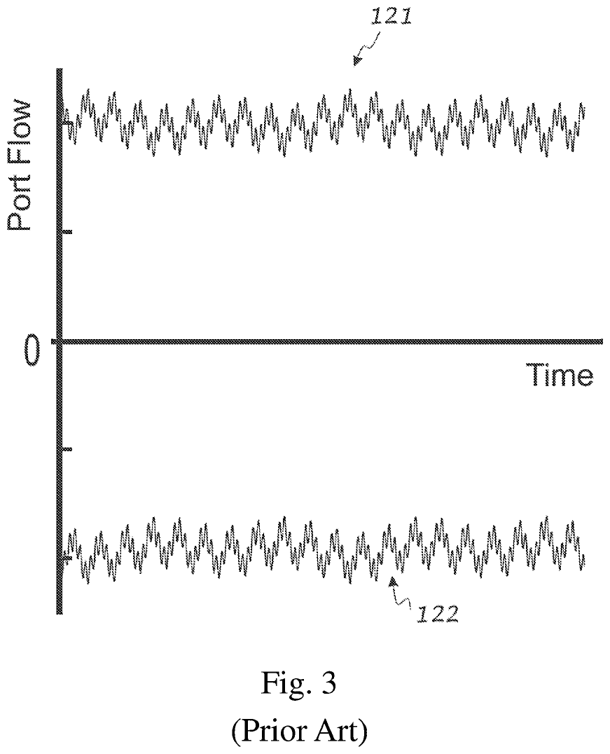

FIG. 3 illustrates a positive flow rate 121 at an outlet port and a negative flow rate 122 at an inlet port when a hydraulic device, similar to that shown in FIG. 1, is operated, e.g., at a constant nominal speed. In a similar fashion to the pressures at the corresponding ports shown in FIG. 2, the flow rate traces include flow pulsations corresponding to oscillations superimposed on the nominal commanded flow rate across a range of different frequencies. This causes the flow rates associated with the separate flow paths and ports to cyclically vary around the nominal commanded flow rate at each port. Similar to the above, traces 121 and 122 are mirror images of each other due to the pulsations being at least partially out of phase with one another (e.g., 180 degrees out of phase).

It should be noted that the traces included in FIGS. 2 and 3 are not data but rather a representation of the expected flow rates and pressures at the ports of a hydraulic device, such as e.g., a hydraulic pump, that is operated under a constant commanded nominal flow rate and pressure differential. However, when the hydraulic device is not operated under constant operating conditions, e.g., speed or flow rate, the nominal flow rate and nominal pressure may also vary. In such an instance, the flow and pressure pulsations corresponding to the cyclic variations shown in the figures may be superimposed on the varying nominal flow rate and/or pressure at any given operating point of the system. Accordingly, the disclosed embodiments for mitigating flow and/or pressure pulsations are not limited to being operated only at constant nominal operating conditions.

In some embodiments, flow pulsations resulting from flow into the intake port and out of the discharge port of a hydraulic device may be at least partially mitigated by incorporating reservoirs that are partially filled with a compressible medium (e.g., a gas). FIG. 4 illustrates an embodiment of a hydraulic system 130 that includes a reversible hydraulic device 131 (e.g., a pump or hydraulic motor), a hydraulic load 104, a first flow path 132, and a second flow path 133. Also, included in the hydraulic circuit of the illustrated system are reservoirs 134 and 135 that are fluidly connected to the first and second flow paths at a location disposed between the hydraulic device and the hydraulic load respectively. Reservoir 134 includes piston 134a and gas filled volume 134b. Reservoir 135 includes piston 135a and gas filled volume 135b. In certain embodiments, reservoirs 134 and 135 may act to mitigate the pulsations flow of hydraulic fluid at port 131a and 131b by at least partially accommodating the flow pulsation by flowing fluid into or out of the reservoir to reduce a magnitude of the pulsations transmitted along the associated flow path to the hydraulic load. The Inventors have recognized that the larger the gas volumes 134b and 135b are in the reservoirs, the more effective the reduction of pump induced pulsations. However, the Inventors have also recognized that the larger the reservoir, the more fluid needs to be pumped by the hydraulic device 131 in order to establish a desired pressure differential between ports 131a and 131b.

In addition to the above, and without wishing to be bound by theory, the Inventors have further recognized that the effectiveness of gas filled reservoirs in mitigating pulsations may be proportional to the compliance of the reservoir. Accordingly, as the pressure in flow path 132 or flow path 133 is increased by operating the pump, the gas volume in the associated reservoir may be compressed. As the gas volume of the reservoir is compressed, the compliance decreases (i.e., the reservoir becomes stiffer), and the reservoir becomes less effective in mitigating hydraulic pulsations. In addition, the relationship between the compliance of a gas filled reservoir and pressure is nonlinear. Accordingly, while one or more reservoirs may be fluidly connected to any flow path in the various embodiments described herein, the Inventors have recognized a need for constructions that may further mitigate the flow and/or pressure pulsations present within a hydraulic system.

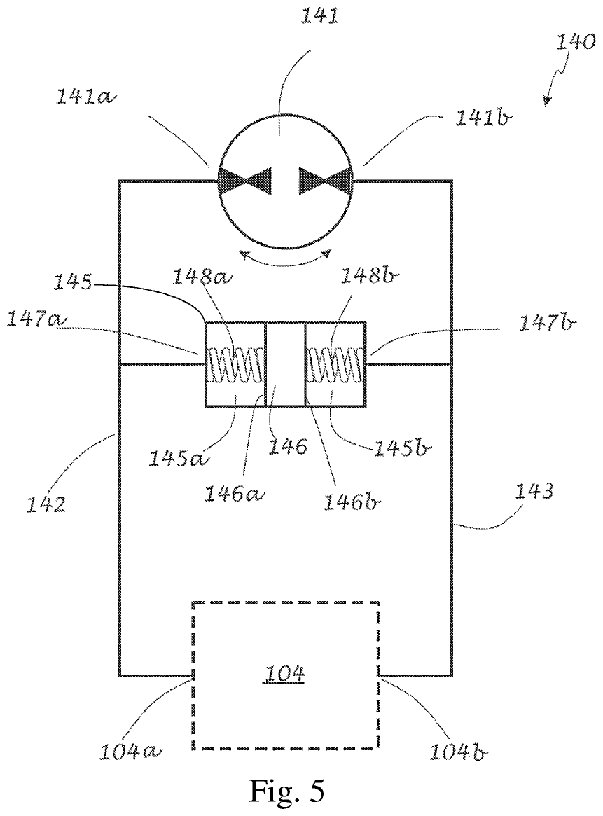

FIG. 5 illustrates a hydraulic system that includes hydraulic device 141, hydraulic load 104, first flow path 142, and second flow path 143. The hydraulic device 141 includes first device port 141a and second device port 141b. The hydraulic system 140 also includes a differential buffer 145. The differential buffer 145 includes a buffer piston 146 which is slidably received in an internal volume of the differential buffer 145. For example, as shown in the embodiment of FIG. 5, the piston 146 may be slidably received within a cylindrical portion of the internal volume such that the buffer piston 146 fluidly separates the internal volume into a first buffer chamber 145a and a second buffer chamber 145b. The buffer piston 146 is disposed between the first buffer chamber 145a and the second buffer chamber 145b such that movement of the buffer piston 146 increases volume of one of the buffer chambers while decreasing the volume of the other buffer chamber. In the embodiment in FIG. 5, opposing piston faces 146a and 146b are exposed to a pressure of the hydraulic fluid in the first and second buffer chambers 145a and 145b, respectively.

The hydraulic device 141 is fluidly connected to the hydraulic load 104 by the first and second flow paths 142 and 143, respectively. Specifically, the first port of the hydraulic device 141a may be fluidly connected to a first port of the hydraulic load 104a by the first flow path 142. Correspondingly, the second port of the hydraulic device 141b may be fluidly connected to a second port of the hydraulic load 104b by the second flow path 143. The first and second buffer chambers 145a and 145b are fluidly connected to flow paths 142 and 143 respectively by two branch flow paths. For example, the buffer chambers 145a and 145b may also include ports 147a and 147b. Thus, the port 147a of the first buffer chamber may be fluidly connected to the first flow path 142 at a location along the first flow path 142 between the hydraulic device 141 and the hydraulic load 104. Correspondingly, the port 147b of the second buffer chamber 145b may be fluidly connected to the second flow path 143 at a location along the second flow path 143 between the hydraulic device 141 and the hydraulic load 104.

In some embodiments, it may be desirable to bias a buffer piston 146 of a differential buffer 145 towards a neutral position when a hydraulic device 141 of the hydraulic system 140 is not being operated, e.g., not creating a differential pressure between its two ports. Accordingly, in some embodiments, a differential buffer 145 may include one or more springs that are operatively coupled to the buffer piston 146 to bias the buffer piston towards a desired neutral position within an interior volume of the differential buffer 145. For example, in the embodiment illustrated in FIG. 5, the differential buffer 145 may include a first spring 148a and a second spring 148b disposed on opposing sides of the buffer piston and in contact with the opposing piston surfaces 146a and 146b, respectively. In some embodiments, a first end portion of each spring may be disposed against a surface of the buffer piston 146 and an opposing end portion of the spring is disposed against a supporting surface such as an interior surface of a housing of the differential buffer 145 as shown in the figure where the springs extend between the piston and an opposing interior surface of the housing. However, the disclosure should not be limited to any specific type of supporting structure for maintaining the springs in a desired position and/or orientation relative to the buffer piston. In either case, the pair of springs may be configured to maintain the position of the piston 146 relative to the differential buffer housing by applying equal and opposite, or effectively equal and opposite, forces on the piston 146 when the differential pressure across the piston 146 is zero or effectively zero. In some embodiments, the spring constants of the two springs may be selected to be equal or effectively equal. For example, the effective spring constant of the one or more springs on either side of the piston may be within 20%, 10%, 5%, 1%, and/or any other appropriate percentage of the larger spring constant of the springs. In some embodiments, either or both of the springs illustrated in the figure may be replaced by multiple springs that in combination are equivalent to the single springs illustrated as the disclosure is not limited to the use of any particular number of springs or types of springs.

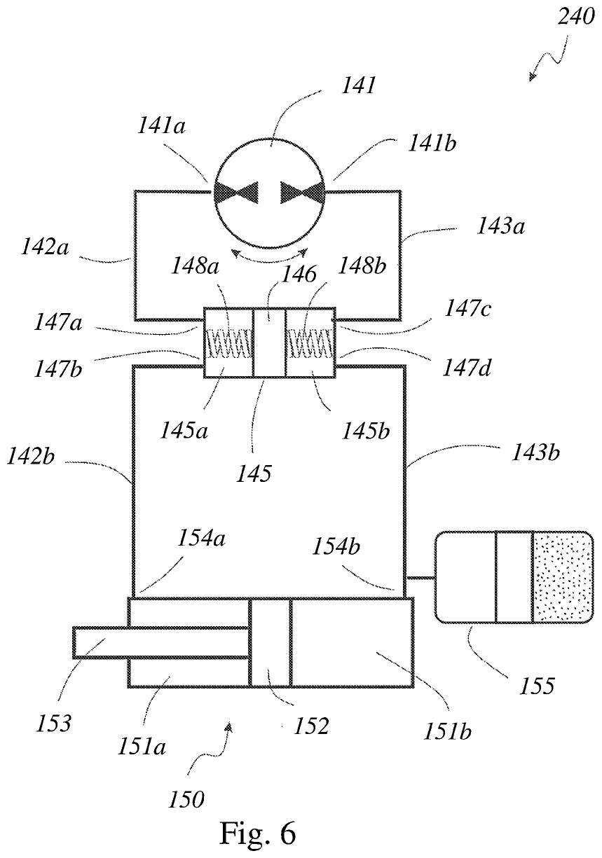

In the above embodiment, branch connections between the flow paths and the differential buffer as well as a generic hydraulic load are described. However, the current disclosure is not limited in this fashion. For example, a hydraulic system including a differential buffer that is connected to the hydraulic device and/or one or more hydraulic loads of the system in a different fashion than that illustrated in FIG. 5 are also contemplated. FIG. 6 illustrates one such embodiment.

Similar to the prior embodiment, FIG. 6 illustrates a hydraulic system 240 that includes a hydraulic device 141 with device ports 141a and 141b. The hydraulic system 240 also includes differential buffer 145 which is also similar to that described above. The differential buffer 145 may again include a buffer piston 146 that is slidably received in an internal volume of the buffer and that fluidly separates the internal volume into first and second buffer chambers 145a and 145b with associated first and second springs 145a and 145b. However, rather than using a branch connection, the differential buffer 145 is constructed with a flow-through configuration. Specifically, as shown in the figure, the first buffer chamber 145a may include two flow ports corresponding to the first and second ports 147a and 147b shown in the figure respectively. The second buffer chamber 145b may also include two flow ports corresponding to the third and fourth ports 147c and 147d. The first device port 141a of the hydraulic device 141 may be fluidly connected to the first port 147a of the first buffer chamber 145a via a first flow path 142a extending between the hydraulic device 141 and the first buffer chamber 145a. Correspondingly, the second port 147b of the first buffer chamber may be fluidly connected to a first port 154a of a hydraulic load, such as the depicted active suspension actuator 150, by a third flow path 142b extending between the first buffer chamber and the hydraulic load. Similarly, the second device port 141b of the hydraulic device may be fluidly connected to a port 147c of the second buffer chamber, i.e. the third port 147c, by a second flow path 143a extending between the hydraulic device 141 and the second buffer chamber 145b. The other port of the second buffer chamber, i.e. the fourth port 147d, may be fluidly connected to a second port 154b of the hydraulic load by a fourth fluid flow path 143b extending between the second buffer chamber 145b and the hydraulic load.

In the depicted embodiment of an active suspension actuator 150, the actuator includes a piston 152 slidably disposed in an interior volume of a housing of the actuator between an extension volume 151a and a compression volume 151b. A piston rod 153 is attached to and extends from at least a first side of the piston 152. The piston may extend to an exterior of the actuator housing. In the depicted embodiment, the extension volume 151a is in fluid communication with the first port 154a of the actuator and the compression volume 151b is in fluid communication with the second port 154b of the actuator. Of course, while a particular active suspension actuator has been shown in the figure, it should be understood that any appropriate hydraulic load may be included in the depicted system as the disclosure is not so limited.

In the depicted embodiment including an active suspension actuator 150 with a piston 152, operation of the hydraulic system may result in the piston extending into an interior volume of the actuator by varying amounts. Thus, the hydraulic system 240 may also include an accumulator 155, or other appropriate reservoir, which may be configured and sized to accommodate hydraulic fluid displaced by the intrusion into or withdrawal of the piston rod 153 from the actuator housing. In the embodiment of FIG. 6, during an extension stroke, the extension volume 151a contracts and the compression volume 151b expands. During a compression stroke, the extension volume expands and the compression volume contracts.

During operation of the hydraulic system 240 of FIG. 6, the hydraulic device 141, such as a pump, may be used to draw fluid from the compression volume 151b and force it into the extension volume 151a, causing the active suspension actuator 150 to undergo compression. In the embodiment in FIG. 6, a quantity of fluid may pumped from the first port 141a of the hydraulic device 141 into the first flow path 142a, into the first port 147a of the first buffer chamber 145a, through the first buffer chamber to the second port 147b of the first buffer chamber, through the third flow path 142b, through the first port 154a of the active suspension actuator, and into the extension volume 151a. This may cause the piston 152 to move in the compression direction causing a quantity of fluid to flow out of the compression volume 151b and through the second port 154b of the actuator 150 or other appropriate hydraulic load. A portion of the quantity of fluid flowing out of the compression volume may flow through the fourth flow path 143b to a port (i.e. the fourth port 147d) of the second buffer chamber 145b, through the second buffer chamber 145b to another port of the second buffer chamber (i.e., the third port 147c), through the second flow path 143a, and into the second device port 141b of the hydraulic device. The remaining portion of the flow leaving port 154b may enter the accumulator 155. It should be noted that in the configuration of FIG. 6, for a given displacement of piston 152, the amount of the fluid that passes through the hydraulic device 141 is equal to the volume swept by the cross-sectional area of the piston 152 minus the cross-sectional area of the piston rod 153. The difference between this volume and the volume that is swept by the piston cross sectional area flows into or out of the accumulator 155 depending on the direction of movement of the piston 152. As a result, the amount of fluid that needs to be pumped by the hydraulic device 141 to establish a desired pressure differential may be significantly less than the embodiment of FIG. 4, where a greater volume of fluid needs to be pumped from one reservoir to another to establish the same pressure differential.

In the above description, a compression cycle of motion of the active suspension actuator 150 is described. However, the active suspension actuator 150 may also undergo an extension cycle in which the piston rod 153 is displaced to extend further out from the actuator housing. Accordingly, the fluid may flow in an opposing direction through the various components described above when the hydraulic device 141 is operated in the opposite direction. Additionally, similar fluid flows through the different flow paths and the differential buffer 145 may occur when the system is controlled to operate hydraulic loads that are different from the depicted active suspension actuator 150 illustrated in FIG. 6.

As noted previously, operation of the hydraulic device 141 may result in flow pulsations propagating along the flow paths 142a and 143a extending between the hydraulic device 141 and the differential buffer 145. Thus, the flow pulsations may originate at the device ports 141a and 141b of the hydraulic device 141 and may propagate to the differential buffer 145 and into the first and second buffer chambers 145a and 145b. As noted previously, the flow pulsations may be at least partially out of phase within the first and second buffer chambers 145a and 145b. Due to the pressure differential associated with these out of phase flow pulsations applied across the buffer piston 146, the flow pulsations reaching the first and second buffer chambers 145a and 145b may induce the buffer piston 146 to move. The resulting movement of the buffer piston 146 may be in a direction and may have a magnitude related to the out of phase pulsations such that a magnitude of the pulsations propagating downstream from the differential buffer 145 towards one or more associated hydraulic loads may be reduced, and in some instances substantially or effectively eliminated, relative to a magnitude of the pulsations upstream from the differential buffer 145 (e.g., between the differential buffer 145 and the hydraulic device 141). For instance, a magnitude of pulsations transmitted along the flow paths 142b and 143b extending between the first and second buffer chambers 145a and 145b and an associated hydraulic load may be less than a magnitude of the pulsations transmitted between the first and second buffer chambers 145a and 145b and the hydraulic device 141. This may correspondingly reduce the magnitude of pulsations applied to the hydraulic load.

The Inventors have recognized that degree of mitigation of flow pulsations using a differential buffer may depend at least partly on how close the pressure pulses are in the opposing chambers of a differential buffer to being 180° out of phase. The further away from 180° out of phase the pulsations are in the separate buffer chambers, the less effective the disclosed pulse mitigation strategy using a differential buffer may be due to there being less destructive interference between the pulses. Accordingly, in some embodiments, it may be desirable to match a compliance and/or impedance of the fluid flow paths 142a and 143a extending between and including the hydraulic device 141 and the corresponding first and second buffer chambers 145a and 145b such that they are substantially equal to one another, or at least within some desired tolerancing of one another. When the flow paths are balanced in this manner, the pulsations that reach the opposing chambers are closer to being 180 degrees out of phase with one another, and thus, may be more effectively cancelled by the motion induced in the piston by those pulsations.

While the operation of the differential buffer to at least partially mitigate flow and/or pressure pulsations propagating from a hydraulic device to an associated hydraulic load is described relative to FIG. 6, a similar method of operation is also applicable to the embodiment of FIG. 5. Specifically, the buffer piston 146 disposed between the first and second buffer chambers 145a and 145b of the differential buffer 145 may still be exposed to pulsations generated at the first and second ports 141a and 141b of the hydraulic device 141. Accordingly, the buffer piston 146 may again move under the cyclic pressure differential resulting from the out of phase pulsations applied to the separate buffer chambers 145a and 145b. This may again result in motion of the buffer piston 146 which may at least partially mitigate the pulsations from being propagated downstream from the connection of the differential buffer 145 to the associated flow path even though a branch connection rather than a flow through connection is depicted in the embodiment of FIG. 5. Thus, it should be understood that the currently disclosed differential buffers may be exposed to pulsations that are present in separate flow paths using direct flow through fluid connections, indirect fluid connections, and/or another appropriate type of connection that permits fluid communication between the buffer chambers and the associated flow paths within a desired frequency range associated with the pulsations.

Referring to FIG. 6, the buffer piston 146 may have a mass m, which refers to the inertial mass of both the piston and the fluid that moves when the piston moves. Similar to other mass-spring systems, the differential buffer 145 may have a natural resonance mode. This means that it does not take the same amount of excitation energy to get the differential buffer piston to move at the frequency of the natural resonance mode as compared to other frequencies. A resonance mode of the differential buffer 145 may be created by the mass m of the buffer piston 146 oscillating on springs 148a and 148b. Mass m may be selected in view of the desired stiffness of the differential buffer 145. Generally, it may be desirable to minimize mass m to reduce its effects on suppressing noise or volumetric ripple, but the mass m and compliances of the springs may also be selected to create a resonance mode (caused by the mass m of the buffer piston 146 oscillating on springs 148a and 148b), which may further increase the effectiveness of the differential buffer 145.

In an example, if the hydraulic device 141 outputs pressure ripple at 100 Hz, for a system with a very low mass m of the buffer piston 146, the stiffness of the hydraulic circuit may be primarily based on the springs (i.e., the springs dominate). At frequencies above the natural resonance, the stiffness of the hydraulic circuit may appear higher than the spring stiffness (i.e., here, mass dominates) as the mass m prevents the buffer piston 146 from moving in response to the pressure ripple. However, if the mass m of the buffer piston 146 is selected so that a natural resonance occurs when pressure ripple is output at 100 Hz, the stiffness of the hydraulic circuit may be much softer than just the spring stiffness.

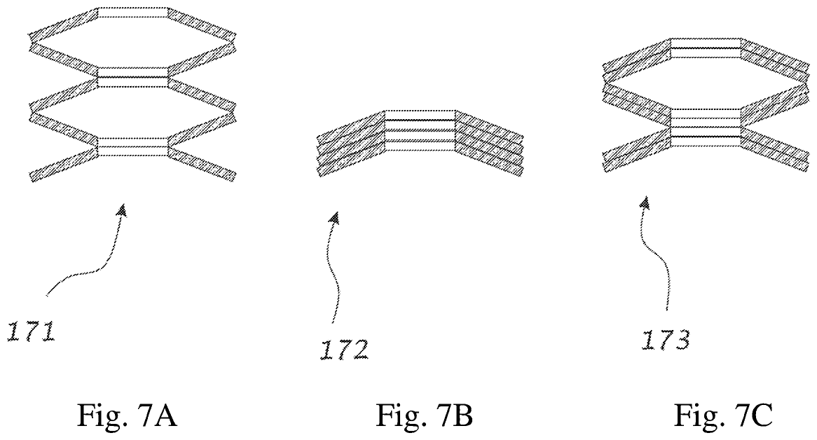

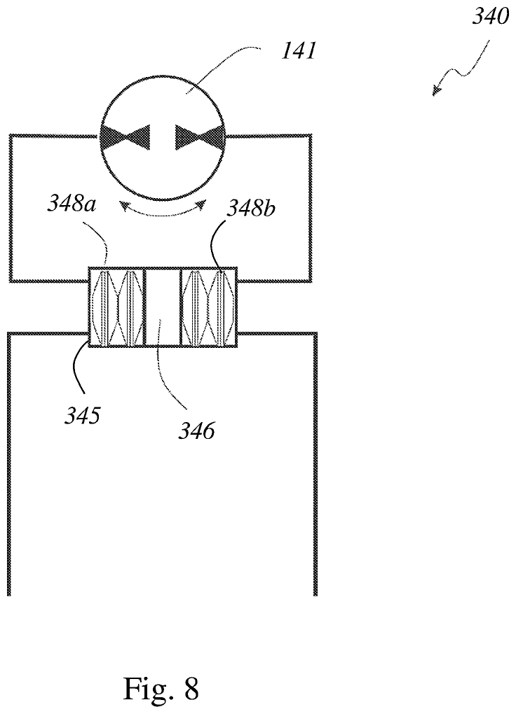

While the embodiments depicted in FIGS. 5 and 6 have included one or more coil springs, the current disclosure is not so limited. For example, the coil springs of the depicted embodiments may be replaced by one or more Belleville washers. As shown in FIGS. 7A-7C, multiple Belleville washers may be stacked in a parallel 171, series 172, or in a combination of parallel and series 173 depending on the desired spring properties. Accordingly, it should be understood that the current disclosure is not limited to any type of spring and/or arrangement of springs. FIG. 8 illustrates one such exemplary embodiment in which a hydraulic system 340 includes a hydraulic device 141, and a differential buffer 345 including a buffer piston 346. Similar to the prior embodiments, the differential buffer 345 includes one or more springs 348a and 348b disposed against opposing surfaces of the buffer piston. However, in the depicted embodiment, the springs correspond to four Belleville washers arranged in a parallel configuration on either side of the buffer piston. Of course, different numbers and arrangements of Belleville washers associated with a buffer piston may also be used as the disclosure is not so limited.

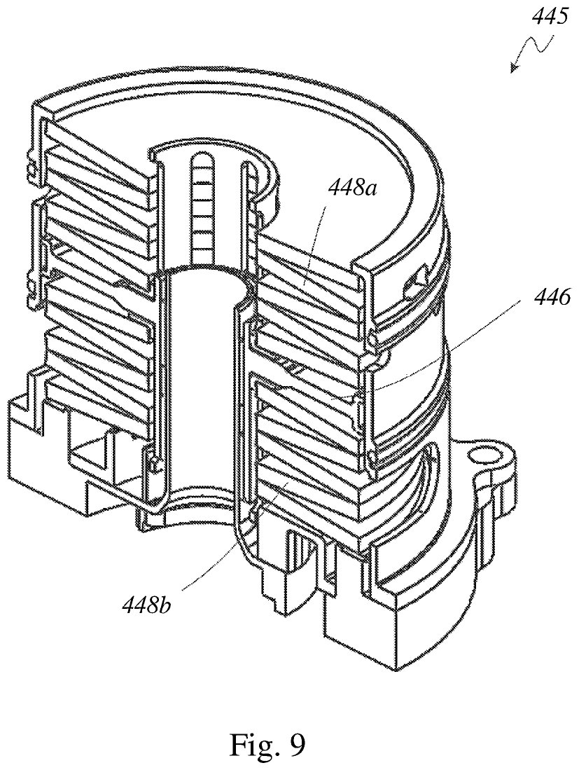

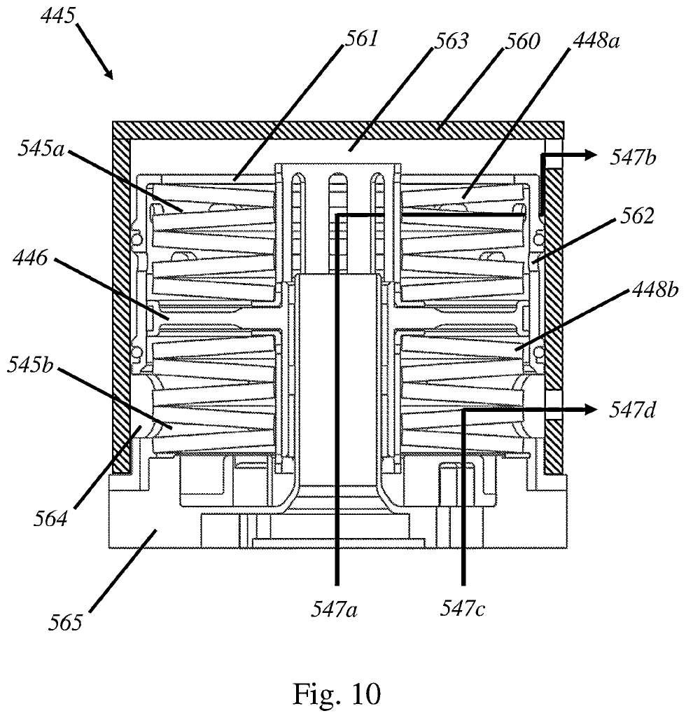

FIG. 9 illustrates a perspective cross section of a compact differential buffer 445 with a piston 446 that is exposed to forces generated by springs 448a and 448b in the form of Belleville washer stacks disposed on opposing sides of the buffer piston 446. FIG. 10 illustrates a front cross-sectional view of the differential buffer 445 with an external housing 560 covering a portion of the differential buffer 445. The differential buffer 445 includes an internal housing 561 that includes one or more openings 562 formed in separate first and second portions of the internal housing 561. These openings 562 may be in fluid communication with either the first or second buffer chambers 545a and 545b respectively. Thus, separate first and second fluid volumes 563 and 564 may be formed between the external and internal housings. The first and second fluid volumes 563 and 564 may be separated from one another by one or more seals, such as the depicted O-rings, disposed between the internal housing 561 and the external housing 560. The differential buffer 445 may also include a base portion 565 that is fluidly sealed to the external housing 560 or other appropriate portion of the differential buffer 445. In the depicted embodiment, ports for the differential buffer 445 may be formed in the base portion 565 and/or external housing 560 of the differential buffer 445. For example, as shown in FIG. 10, a first port 547a in fluid communication with the first buffer chamber 545a is formed in the base portion 565, such as the depicted central support shaft, and a separate port 547b in fluid communication with the first buffer chamber 545a is formed in the external housing 560. Thus, fluid may flow between the first and second ports through the first buffer chamber 545a and the corresponding first volume 563 disposed between the external and internal housings 560 and 561. Correspondingly, a third port 547c may also be formed in the base portion 565 such that it is in fluid communication with the second buffer chamber and a fourth port 547d formed in the external housing 560 such that fluid may flow between the third and fourth ports through the second buffer chamber and the corresponding second volume disposed between the external and internal housings.

While the above embodiments have primarily illustrated differential buffers in which fluid flows directly through the buffer chambers, embodiments in which fluid does not flow directly through a buffer chamber of a differential buffer to a hydraulic load are also contemplated. For example, T-junction connections similar to that shown in FIG. 5 where fluid may flow into and out of a differential buffer from a primary flow path may be used. Additionally, an embodiment similar to that shown in FIG. 10 where two or more ports are formed in the external housing 560 and are in fluid communication with the same fluid volume disposed between the internal housing 561 and external housing 560 may be used. In such an embodiment, the fluid may flow between the two ports formed in the external housing 560 through the connecting volume of fluid. However, that volume of fluid may be in fluid communication with the associated buffer chamber through the one or more openings formed in the internal housing 561. Accordingly, the piston may still be subjected to the flow pulsations emitted by an associated hydraulic device, but the flow path extending between the hydraulic device and load may not pass directly through the buffer chambers of the differential buffer. Thus, it should be understood that the current disclosure is meant to include any number of different arrangements of the ports, housings, and fluid connections associated with a differential buffer as the disclosure is not limited to any particular construction.

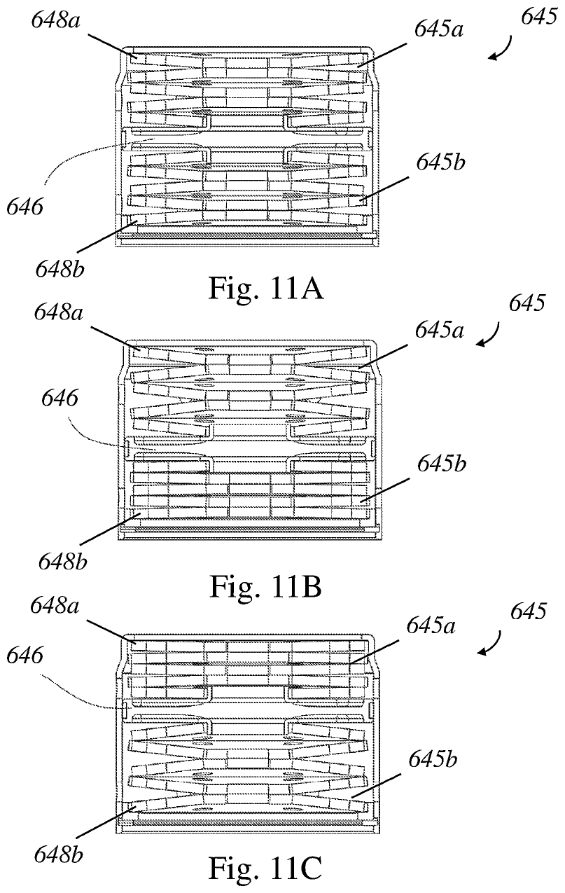

FIGS. 11A-11C illustrate three front cross-sectional views of another embodiment of differential buffer 645 similar to that shown in FIGS. 9-10. The differential buffer again includes a buffer piston 646 disposed between first and second buffer chambers 645a and 645b. The buffer piston 646 is illustrated at different positions in the different figures. FIG. 11A shows the differential buffer 645 with the buffer piston 646 in a neutral position where the pressure on the two faces of the buffer piston 646 are equal or effectively equal and the first and second springs 648a and 648b operatively coupled to the opposing sides of the piston may be in the neutral state as well. FIG. 11B shows that the buffer piston 646 has moved down compressing the second buffer chamber 645b and the associated second spring 648b while expanding the first buffer chamber 645a and first spring 648a due to a pressure in the first buffer chamber increasing relative to the second buffer chamber. FIG. 11C illustrates the opposite pressure differential across the buffer piston 646 where an increased pressure is present in the second buffer chamber 645b relative to the first buffer chamber 645a causing the buffer piston 646 to be moved upwards in the opposite direction compressing the first buffer chamber 645a and first spring 648a while expanding the second buffer chamber 645b and second spring 648b. Again, it is this relative movement of the buffer piston 646 due to pressure differentials applied across the piston that permits the differential buffer to help mitigate flow and/or pressure pulsations generated by a fluidly connected hydraulic device.

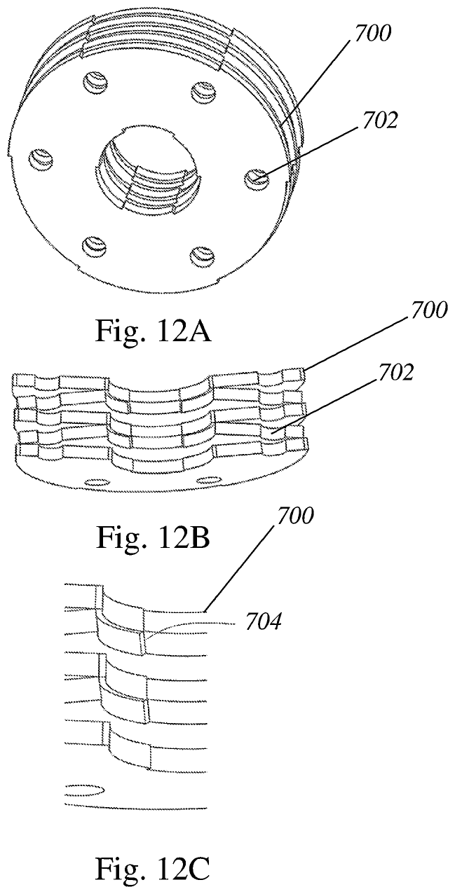

FIG. 12 illustrates aspects of a Belleville washer stack which may be used with the various embodiments of a differential buffer disclosed herein. In the depicted embodiment, the Belleville washers 700 may include one or more through holes 702 extending from a first planar surface to a second opposing planar surface of the Belleville washer. In embodiments where a central shaft extends through the stack of Belleville washers, these one or more through holes may be separate from a central hole formed in the stack of Belleville washers. Without wishing to be bound by theory, the presence of these one or more through holes formed in the Belleville washers may help to avoid the entrapment of fluid between two opposing Belleville washers that are compressed towards one another. This may help to facilitate the free flow of fluid through a differential buffer including such a spring arrangement. In some embodiments, the Belleville washers may also include one or more interlocking features 704, such as the depicted tongue and groove arrangement between adjacent portions of contacting Belleville washers. These interlocking features may help to prevent both lateral and rotational movement of the Belleville washers relative to one another which may improve the overall Belleville washer stack stability during operation.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A hydraulic system comprising:
a hydraulic device with a first device port and a second device port;
a differential buffer with a first buffer port and a second buffer port;
a first flow path that fluidly connects the first device port to the first buffer port; and
a second flow path that fluidly connects the second device port with the second buffer port.

2. The system of claim 1 wherein the differential buffer includes a first buffer chamber and a second buffer chamber that are fluidly separated by a buffer piston slidably received in the differential buffer, wherein the first buffer chamber is fluidly connected to the first device port and the second buffer chamber is fluidly connected to the second device port

3. The system of claim 2, further comprising a first spring configured to resist motion of the buffer piston in a first direction and a second spring configured to resist motion of the buffer piston in a second direction opposite the first direction.

4. The system of claim 3, wherein the first and second springs are coil springs.

5. The system of claim 3, wherein the first and second springs include a Belleville washer.

6. The system of any one of claims 2-5, wherein the buffer piston is configured to move in a first direction when a pressure in the first buffer chamber is greater than a pressure in the second buffer chamber and in a second direction, opposite the first direction, when the pressure in the second buffer chamber is greater than the pressure in the first buffer chamber.

7. The system of claim 6, wherein when the buffer piston moves in the first direction a first volume of the first buffer chamber expands and a second volume of the second buffer chamber contracts, and wherein when the buffer piston moves in the second direction opposite the first direction, the second volume of the second buffer chamber expands and the first volume of the first buffer chamber contracts.

8. The system of any one of the preceding claims, wherein the hydraulic device is configured to operate as a hydraulic pump in at least one mode of operation.

9. The system of any one of the preceding claims, wherein the hydraulic device is selected from the group consisting of a hydraulic pump and a hydraulic motor.

10. The system of any of the preceding claims, wherein the first flow path has a first net compliance and the second flow path has a second net compliance, and wherein the first net compliance is within 20% of the second net compliance within a predetermined frequency range.

11. The system of any one of claims 1-9, wherein the first fluid flow path has a first net impedance and the second fluid flow path has a second net impedance, and wherein the first net impedance is within 20% of the second net impedance within a predetermined frequency range.

12. The system of any one of the preceding claims, wherein the differential buffer includes a third port and a fourth port, and wherein the third and fourth ports are in fluid communication with a hydraulic load.

13. The system of claim 12, wherein the hydraulic load is an active suspension actuator.

14. An active suspension actuator system, comprising:
a hydraulic device including a first device port and a second device port;
a differential buffer with a first buffer chamber and a second buffer chamber that are fluidly separated by a buffer piston slidably received in the differential buffer, wherein the first buffer chamber is fluidly connected to the first port of the hydraulic device and the second buffer chamber is fluidly connected to the second port of the hydraulic device; and
a hydraulic actuator with a first actuator chamber and a second actuator chamber that are fluidly separated by an actuator piston slidably received in the hydraulic actuator, wherein the first actuator chamber is fluidly connected to the first buffer chamber and the second actuator chamber is fluidly connected to the second buffer chamber.

15. The system of claim 14, further comprising a first spring configured to resist motion of the buffer piston in a first direction and a second spring configured to resist motion of the buffer piston in a second direction opposite the first direction.

16. The system of claim 15, wherein the first and second springs are coil springs.

17. The system of claim 15, wherein the first and second springs include a Belleville washer.

18. The system of any one of claims 14-17, wherein the buffer piston is configured to move in a first direction when a pressure in the first buffer chamber is greater than a pressure in the second buffer chamber and in a second direction, opposite the first direction, when the pressure in the second buffer chamber is greater than the pressure in the first buffer chamber.

19. The system of claim 18, wherein when the buffer piston moves in the first direction a first volume of the first buffer chamber expands and a second volume of the second buffer chamber contracts, and wherein when the buffer piston moves in the second direction opposite the first direction, the second volume of the second buffer chamber expands and the first volume of the first buffer chamber contracts.

20. The system of any one of claims 14-19, wherein the hydraulic device is configured to operate as a hydraulic pump in at least one mode of operation.

21. The system of any one of claims 14-20, wherein the hydraulic device is selected from the group consisting of a hydraulic pump and a hydraulic motor.

22. The system of any one of claims 14-21, wherein a first flow path extending between and including the first device port and the first buffer chamber has a first net compliance and a second flow path extending between and including the second device port and the second buffer chamber has a second net compliance, and wherein the first net compliance is within 20% of the second net compliance within a predetermined frequency range.

23. The system of any one of claims 14-22, wherein a first flow path extending between and including the first device port and the first buffer chamber has a first net impedance and a second flow path extending between and including the second device port and the second buffer chamber has a second net impedance, and wherein the first net impedance is within 20% of the second net impedance within a predetermined frequency range.

24. The system of any one of claims 14-23, wherein the differential buffer includes a third port fluidly coupled to the first buffer chamber and a fourth port fluidly coupled to the second buffer chamber, and wherein the third port of the differential buffer is fluidly connected to the first actuator chamber and the fourth port is fluidly connected to the second actuator chamber.

25. A method for operating a hydraulic system, the method comprising:
applying flow pulsations to a first flow path fluidly connected to a first buffer chamber and a second flow path fluidly connected to a second buffer chamber, wherein the flow pulsations in the first buffer chamber are at least partially out of phase with the flow pulsations in the second buffer chamber; and
displacing a buffer piston disposed between the first buffer volume and the second buffer volume due at least in part to a phase difference between the flow pulsations in the first and second buffer chambers.

26. The method of claim 25, wherein displacing the buffer piston varies a volume of the first buffer chamber and a volume of the second buffer chamber to reduce a magnitude of the flow pulsations transmitted to a hydraulic load.

27. The method of claim 26, wherein the hydraulic load is an active suspension actuator.

28. The method of any one of claims 25-27, further comprising biasing the buffer piston towards a neutral configuration.

29. The method of any one of claims 25-28, further comprising moving the buffer piston in a first direction when a pressure in the first buffer chamber is greater than a pressure in the second buffer chamber and in a second direction, opposite the first direction, when the pressure in the second buffer chamber is greater than the pressure in the first buffer chamber.

30. The method of any one of claim 29, wherein when the buffer piston moves in the first direction a first volume of the first buffer chamber expands and a second volume of the second buffer chamber contracts, and wherein when the buffer piston moves in the second direction opposite the first direction, the second volume of the second buffer chamber expands and the first volume of the first buffer chamber contracts.

31. The method of any one of claims 25-30, further comprising generating the flow pulsations with a hydraulic device.

32. The method of claim 31, wherein the hydraulic device is configured to operate as a hydraulic pump in at least one mode of operation.

33. The method of any one of claims 31 and 32, wherein the hydraulic device is selected from the group consisting of a hydraulic pump and a hydraulic motor.

34. The method of any one of claims 25-33, wherein the phase difference of the hydraulic flow pulsations on each side of the buffer piston are between or equal to 140 degrees and 220 degrees out of phase.

35. A hydraulic system comprising:
a hydraulic device with a first device port and a second device port;
a differential buffer with a first buffer port and a second buffer port;
a first flow path that fluidly connects the first device port to the first buffer port; and
a second flow path that fluidly connects the second device port with the second buffer port.

36. The system of claim 35, wherein the differential buffer includes a first buffer chamber and a second buffer chamber that are fluidly separated by a buffer piston slidably received in the differential buffer, wherein the first buffer chamber is fluidly connected to the first device port and the second buffer chamber is fluidly connected to the second device port

37. The system of claim 36, further comprising a first spring configured to resist motion of the buffer piston in a first direction and a second spring configured to resist motion of the buffer piston in a second direction opposite the first direction.

38. The system of claim 37, wherein the buffer piston is configured to have a resonance mode within a frequency range of flow pulsations generated by the hydraulic device.
